(19) United States
(12) Patent Application Publication
(10) Pub. No.: US 2009/0188238 A1
(43) Pub. Date: Jul. 30, 2009

(54) Exhaust Purification Device of Compression Ignition Type Internal Combustion Engine

(75) Inventors: Kohei Yoshida, Gotenba-shi (JP); Hiromasa Nishioka, Susono-shi (JP); Kotaro Hayashi, Mishima-shi (JP); Takamitsu Asanuma, Mishima-shi (JP); Shinya Hirota, Susono-shi (JP); Hiroshi Otsuki, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/309,490

(22) PCT Filed: Jan. 24, 2008
(86) PCT No.: PCT/JP2008/051464

§ 371 Date: Jan. 21, 2009

(30) Foreign Application Priority Data
Jan. 26, 2007 (JP) 2007-016196

(51) Int. Cl. F02D 43/00; F01N 3/10; H02P 31/00

(52) U.S. Cl. 60/285; 60/299; 318/452; 903/930

(57) ABSTRACT

In an internal combustion engine, the engine is formed so that an output of an electric motor can be superposed on an output of the engine. An SO_{X} trap catalyst able to trap the SO_{X} contained in the exhaust gas is arranged inside the engine exhaust passage upstream of the NO_{X} storage catalyst. The vehicle drive power from the engine and the vehicle drive power from the electric motor are adjusted so that the SO_{X} trap rate of the SO_{X} trap catalyst is maintained at a predetermined high SO_{X} trap rate.

### TECHNICAL FIELD

The present invention relates to an exhaust purification device of a compression ignition type internal combustion engine.

### BACKGROUND ART

Known in the art is an internal combustion engine arranging in an engine exhaust passage an NO_{X} storage catalyst storing NO_{X} contained in exhaust gas when the air-fuel ratio of the inflowing exhaust gas is lean and releasing the stored NO_{X} when the air-fuel ratio of the inflowing exhaust gas becomes a stoichiometric air-fuel ratio or rich. In this internal combustion engine, NO_{X} formed when burning fuel under a lean air-fuel ratio is stored in the NO_{X} storage catalyst. On the other hand, as the NO_{X} storage catalyst approaches saturation of the NO_{X} storage ability, the air-fuel ratio of the exhaust gas is temporarily made rich, whereby NO_{X} is released from the NO_{X} storage catalyst and reduced.

However, fuel and lubrication oil contain sulfur. Therefore, the exhaust gas also contains SO_{X}. This SO_{X} is stored together with the NO_{X} in the NO_{X} storage catalyst. This SO_{X} is not released from the NO_{X} storage catalyst by just making the exhaust gas a rich air-fuel ratio. Therefore, the amount of SO_{X} stored in the NO_{X} storage catalyst gradually increases. As a result, the storable NO_{X} amount ends up gradually decreasing.

However, in this case, the SO_{X} stored in the NO_{X} storage catalyst is gradually released from the NO_{X} storage catalyst if raising the temperature of the NO_{X} storage catalyst and making the exhaust gas flowing into the NO_{X} storage catalyst a rich air-fuel ratio. However, in this case, during the release of SO_{X}, if the NO_{X} storage catalyst falls in temperature, the SO_{X} release action ends up stopping. If the SO_{X} release action ends up stopping once, the SO_{X} release action is not performed until the NO_{X} storage catalyst again rises in temperature. Therefore, if the NO_{X} storage catalyst falls in temperature during release of SO_{X}, getting the SO_{X} released will require a long time.

Therefore, there is known a hybrid diesel engine provided with an electric motor, stopping the operation of the engine when the exhaust temperature falls so as to suppress the flow of low temperature exhaust gas into the NO_{X} storage catalyst and the fall of the NO_{X} storage catalyst in temperature, and using the electric motor at that time to drive the vehicle (for example, see Japanese Patent Publication (A) No. 2005-133563). In this diesel engine, when the NO_{X} storage catalyst falls in temperature, the NO_{X} storage catalyst is not raised in temperature to continue the SO_{X} release action, but it is allowed to stop the SO_{X} release action by the drop in temperature of the NO_{X} storage catalyst.

As opposed to this, there is known an internal combustion engine arranging an SO_{X} trap catalyst able to trap SO_{X} in the exhaust gas in the engine exhaust passage upstream of the NO_{X} storage catalyst (see Japanese Patent Publication (A) No. 2005-133610). In this internal combustion engine, the SO_{X} contained in the exhaust gas is trapped by the SO_{X} trap catalyst, therefore the flow of SO_{X} into the NO_{X} storage catalyst is inhibited.

In this regard, when using such an SO_{X} trap catalyst, if the SO_{X} trap rate falls and SO_{X} flows into the NO_{X} storage catalyst, that is, if the action of the SO_{X} trap catalyst in blocking the flow of SO_{X} into the NO_{X} storage catalyst is stopped, there is no longer any meaning to arranging the SO_{X} trap catalyst upstream of the NO_{X} storage catalyst. Therefore, when using such an SO_{X} trap catalyst, it becomes necessary to continue to maintain the SO_{X} trap rate at a high SO_{X} trap rate without the action of blocking the inflow of SO_{X} into the NO_{X} storage catalyst stopping.

In this regard, the SO_{X} trap rate changes along with a change in the engine operating state. If the SO_{X} trap catalyst falls in temperature or the exhaust gas flowing through the SO_{X} trap catalyst becomes higher in spatial velocity, the SO_{X} trap rate will fall. At this time, it becomes necessary to make the SO_{X} trap rate rise to continue to maintain the SO_{X} trap rate at a high SO_{X} trap rate, but no consideration is being given to this at all at present.

### DISCLOSURE OF THE INVENTION

An object of the present invention is to provide an exhaust purification device of an internal combustion engine able to maintain the SO_{X} trap rate at a high SO_{X} trap rate.

According to the present invention, there is provided an exhaust purification device of compression ignition type internal combustion engine arranging, in an engine exhaust passage, an SO_{X} trap catalyst able to trap SO_{X} contained in exhaust gas and arranging, in the exhaust passage downstream of the SO_{X} trap catalyst, an NO_{X} storage catalyst storing NO_{X} contained in the exhaust gas when the air-fuel ratio of an inflowing exhaust gas is lean and releasing stored NO_{X} when the air-fuel ratio of the inflowing exhaust gas becomes a stoichiometric air-fuel ratio or rich, wherein the device is provided with an electric power device able to generate vehicle drive power separate from the vehicle drive power from the engine and able to generate electric power from the engine, and the vehicle drive power from the engine and the vehicle drive power from the electric power device are adjusted so that a SO_{X} trap rate of the SO_{X} trap catalyst is maintained at a predetermined high SO_{X} trap rate.

### BRIEF DESCRIPTION OF THE DRAWINGS

FIG. 1 is an overview of a compression ignition type internal combustion engine;

FIG. 2 is a cross-sectional view of the surface part of a substrate of an NO_{X} purification catalyst;

FIG. 3 is a cross-sectional view of the surface part of a substrate of an SO_{X} trap catalyst;

FIG. 4 is a view showing the SO_{X} trap rate,

FIG. 5 is a view showing the SO_{X} trap rate;

FIG. 6 is a view showing the output torque of an internal combustion engine;

FIG. 7 is a flowchart for operational control; and

FIG. 8 is a view showing another embodiment of an electric power device.

### BEST MODE FOR CARRYING OUT THE INVENTION

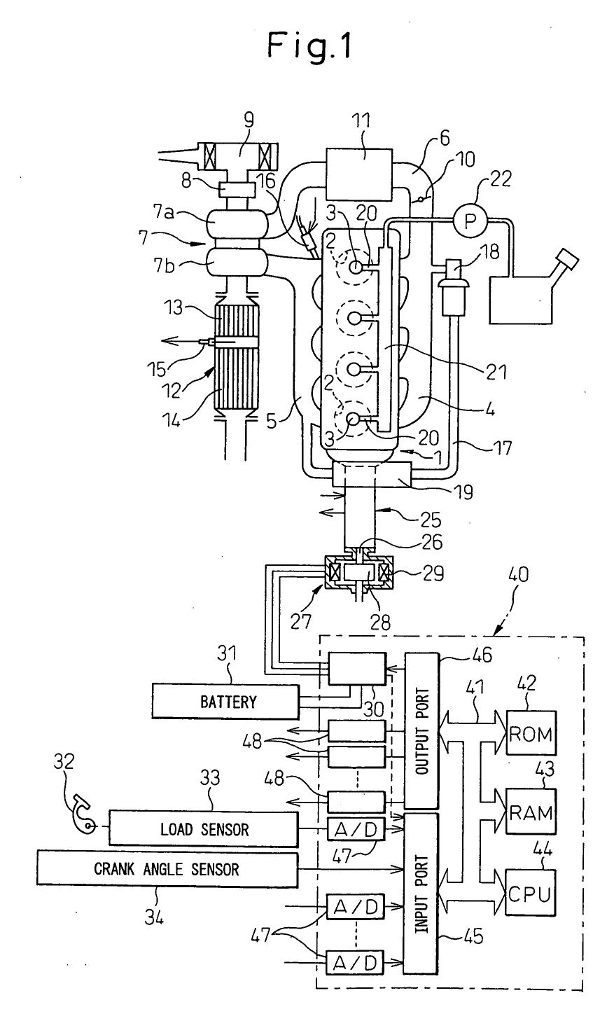

FIG. 1 is an overview of a compression ignition type internal combustion engine.

Referring to FIG. 1, 1 indicates an engine body, 2 a combustion chamber of each cylinder, 3 an electronically controlled fuel injector injecting fuel into each combustion chamber 2, 4 an intake manifold, and 5 an exhaust manifold. The intake manifold 4 is connected through an intake duct 6 to a compressor 7a of an exhaust turbocharger 7, while an inlet of the compressor 7a is connected through an intake air detector 8 to an air cleaner 9. Inside the intake duct 6, a throttle valve 10 driven by the step motor is arranged. Further, around the intake duct 6, a cooling device 11 for cooling the intake air flowing through the intake duct 6 is arranged. In the embodiment shown in FIG. 1, the engine cooling water is led into the cooling device 11 where the engine cooling water is used to cool the intake air.

On the other hand, the exhaust manifold 5 is connected to an inlet of an exhaust turbine 7b of the exhaust turbocharger 7. The outlet of the exhaust turbine 7b is connected to an inlet of a catalyst converter 12. Inside the catalyst converter 12, an SO_{X} trap catalyst 13 and NO_{X} storage catalyst 14 are arranged in order from the upstream side. Inside the catalyst converter 12 between the SO_{X} trap catalyst 13 and the NO_{X} storage catalyst 14, a temperature sensor 15 for detecting the temperature of the exhaust gas flowing out from the SO_{X} trap catalyst 13 is provided. In the embodiment according to the present invention, the temperature of the SO_{X} trap catalyst 13 is estimated from the detection value of this temperature sensor 15. Further, inside the exhaust manifold 5, a reducing agent feed valve 16 for feeding a reducing agent comprised of for example a hydrocarbon into the exhaust manifold 5 is attached.

The exhaust manifold 5 and intake manifold 4 are connected to each other through an exhaust gas recirculation (hereinafter referred to as “EGR”) passage 17. Inside the EGR passage 17, an electronic control type EGR control valve 18 is arranged. Further, around the EGR passage 17, a cooling device 19 for cooling the EGR gas flowing through the EGR passage 17 is arranged. In the embodiment shown in FIG. 1, engine cooling water is led to the cooling device 19 where the engine cooling water cools the EGR gas. On the other hand, each fuel injector 3 is connected through a fuel tube 20 to a common rail 21. This common rail 21 is fed with fuel from an electronically controlled variable discharge fuel pump 22. The fuel fed into the common rail 21 is fed through each fuel tube 20 into a fuel injector 3.

On the other hand, in the embodiment shown in FIG. 1, a transmission 25 is coupled with the output shaft of the engine, while an electric motor 27 is coupled with the output shaft 26 of the transmission 25. In this case, as the transmission 25, it is possible to use an ordinary gear-type automatic transmission provided with a torque converter, a manual transmission, a gear-type automatic transmission of a type designed to automatically perform the clutch operation and gear shift operation in a manual transmission provided with a clutch, etc.

Further, the electric motor 27 coupled with the output shaft 26 of the transmission 25 comprises an electric power device able to generate vehicle drive power separate from the vehicle drive power from the engine and able to generate electric power by the engine. In this embodiment shown in FIG. 1, this electric motor 27 comprises an AC synchronous motor provided with a rotor 28 attached on an output shaft 26 of the transmission 25 and attaching a plurality of permanent magnets to the outer circumference and a stator 29 provided with an excitation coil forming a rotary magnetic field. The excitation coil of the stator 29 is connected to a motor drive control circuit 30, while this motor drive control circuit 30 is connected to a battery 31 generating a DC high voltage.

The electronic control unit 40 is comprised of a digital computer and is provided with a ROM (read only memory) 42, RAM (random access memory) 43, CPU (microprocessor) 44, input port 45, and output port 46 which are connect to each other by a bi-directional bus 41. The output signals of the intake air detector 8 and the temperature sensor 15 are input through corresponding AD converters 47 to an input port 45. Further, the input port 45 receives as input various signals showing the gear of the transmission 25, the rotational speed of the output shaft 26, etc.

On the other hand, the accelerator pedal 32 is connected to a load sensor 33 generating an output voltage proportional to the amount of depression L of an accelerator pedal 32. The output voltage of the load sensor 33 is input through a corresponding AD converter 47 to the input port 45. Further, the input port 45 is connected to a crank angle sensor 34 generating an output pulse each time the crankshaft rotates by for example 10°. On the other hand, the output port 46 is connected through a corresponding drive circuit 48 to the fuel injector 3, the reducing agent feed valve 16, EGR control valve 18, transmission 25, motor drive control circuit 30, etc.

The feed of electric power from the electric motor 27 to the excitation coil of the stator 29 is normally stopped. At this time, the rotor 28 rotates together with the output shaft 26 of the transmission 25. On the other hand, when driving the electric motor 27, the DC high voltage of the battery 31 is converted at the motor drive control circuit 30 to a three-phase alternating current of a frequency of fm and a current value of Im, and this three-phase alternating current is fed to the excitation coil of the stator 29. This frequency fm is the frequency required for making the rotating magnetic field generated by the excitation coil rotate in synchronization with the rotation of the rotor 28. This frequency fm is calculated by a CPU 44 based on the rotational speed of the output shaft 26. At the motor drive control circuit 30, this frequency fm is made the frequency of the three-phase alternating current.

On the other hand, the output torque of the electric motor 27 is substantially proportional to the current value Im of the three-phase alternating current. This current value Im is calculated at the CPU 44 based on the required output torque of the electric motor 27. In the motor drive control circuit 30, this current value Im is made the current value of the three-phase alternating current.

Further, if driving the electric motor 27 by external force, the electric motor 27 operates as a generator. At this time, the generated electric power is recovered by the battery 31. Whether to use external force to drive the electric motor 27 is judged by the CPU 44. When it is judged that external force should be used to drive the electric motor 27, a motor control circuit 3 is used to control the electric motor 27 so that the generated electric power is recovered at the battery 31.

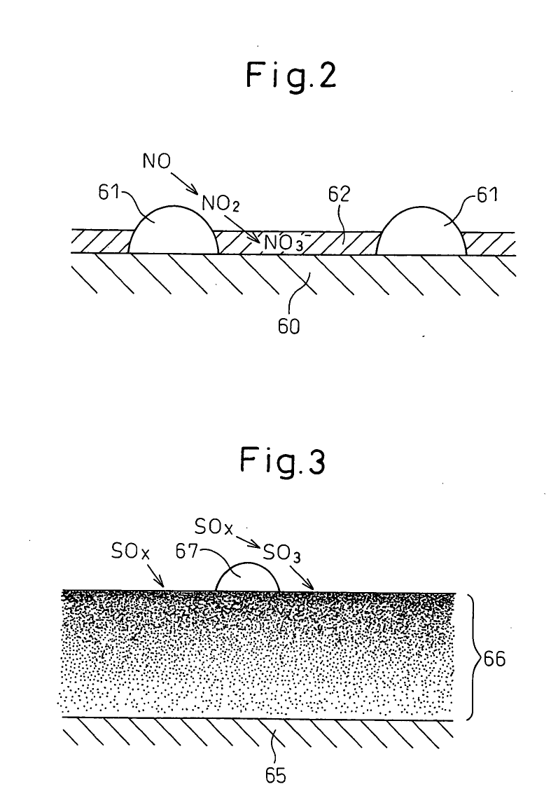

Next, the NO_{X} storage catalyst 14 shown in FIG. 1 will be explained. This NO_{X} storage catalyst 14 is comprised of a substrate on which for example for example a catalyst carrier comprised of alumina is carried. FIG. 2 illustrates the cross-section of the surface part of this catalyst carrier 60. As shown in FIG. 2, the catalyst carrier 60 carries a precious metal catalyst 61 diffused on the surface. Further, the catalyst carrier 60 is formed with a layer of an NO_{X} absorbent 62 on its surface.

In the embodiment according to the present invention, as the precious metal catalyst 61, platinum Pt is used. As the ingredient forming the NO_{X} absorbent 62, for example, at least one element selected from potassium K, sodium Na, cesium Cs, and other such alkali metals, barium Ba, calcium Ca, and other such alkali earths, lanthanum La, yttrium Y, and other rare earths is used.

If the ratio of the air and fuel (hydrocarbons) fed into the engine intake passage, combustion chamber 2, and exhaust passage upstream of the NO_{X} storage catalyst 14 is called the “air-fuel ratio of the exhaust gas”, an NO_{X} absorption and release action such that the NO_{X} absorbent 62 absorbs the NO_{X} when the air-fuel ratio of the exhaust gas is lean and releases the absorbed NO_{X} when the oxygen concentration in the exhaust gas falls is performed.

That is, explaining this taking as an example the case of using barium Ba as the ingredient forming the NO_{X} absorbent 62, when the air-fuel ratio of the exhaust gas is lean, that is, the oxygen concentration in the exhaust gas is high, the NO contained in the exhaust gas, as shown in FIG. 2, is oxidized on the platinum Pt 61 to become NO₂, next is absorbed in the NO_{X} absorbent 62 and bonds with the barium oxide BaO to diffuse in the form of nitrate ions NO₃⁻ into the NO_{X} absorbent 52. In this way, NO_{X} is absorbed in the NO_{X} absorbent 62. So long as the oxygen concentration in the exhaust gas is high, NO₂ is formed on the platinum Pt 61. So long as the NO_{X} absorbent 62 is not saturated in NO_{X} absorption ability, NO₂ is absorbed in the NO_{X} absorbent 62 and nitrate ions NO₃⁻ are formed.

As opposed to this, for example if the reducing agent feed valve 16 feeds the reducing agent to make the exhaust gas a rich air-fuel ratio or stoichiometric air-fuel ratio, the oxygen concentration in the exhaust gas falls, so the reaction proceeds in the reverse direction (NO₃⁻→NO₂), therefore the nitrate ions NO₃⁻ in the NO_{X} absorbent 62 are released in the form of NO₂ from the NO_{X} absorbent 62. Next, the released NO_{X} is reduced by the unburned HC and CO contained in the exhaust gas.

In this way, when the air-fuel ratio of the exhaust gas is lean, that is, when burning the fuel under a lean air-fuel ratio, the NO_{X} in the exhaust gas is absorbed in the NO_{X} absorbent 62. However, when the fuel continues to be burned under a lean air-fuel ratio, the NO_{X} absorbent 62 eventually ends up becoming saturated in NO_{X} absorption ability, therefore the NO_{X} absorbent 62 ends up becoming unable to absorb the NO_{X}. Therefore, in this embodiment of the present invention, before the NO_{X} absorbent 62 becomes saturated in absorption ability, the reducing agent is fed from the reducing agent feed valve 16 to make the exhaust gas temporarily rich air-fuel ratio and thereby make the NO_{X} absorbent 62 release the NO_{X}.

On the other hand, the exhaust gas contains SO_{X}, that is, SO₂. If this SO₂ flows into the NO_{X} storage catalyst 62, this SO₂ is oxidized on the platinum Pt 61 and becomes SO₃. Next, this SO₃ is absorbed in the NO_{X} absorbent 62, bonds with the barium oxide BaO, is diffused in the form of sulfate ions SO₄²⁻ in the NO_{X} absorbent 62, and forms stable sulfate BaSO₄. However, the NO_{X} absorbent 62 has a strong basicity, so this sulfate BaSO₄ is stable and hard to break down. If just making the exhaust gas rich air-fuel ratio, the sulfate BaSO₄ remains as is without breaking down. Therefore, in the NO_{X} absorbent 62, the sulfate BaSO₄ increases along with the elapse of time, therefore the NO_{X} amount which the NO_{X} absorbent 62 can absorb falls along with the elapse of time.

In this regard, in this case, if making the air-fuel ratio of the exhaust gas flowing into the NO_{X} storage catalyst 14 rich in the state where the temperature of the NO_{X} storage catalyst 14 is made to rise to the SO_{X} release temperature of 600° C. or more, the NO_{X} absorbent 62 releases SO_{X}. However, in this case, the NO_{X} absorbent 62 only releases a little SO_{X} at a time. Therefore, to make the NO_{X} absorbent 62 release all of the absorbed SO_{X}, it is necessary to make the air-fuel ratio rich over a long time, therefore there is the problem that a large amount of fuel or reducing agent becomes necessary. Further, the SO_{X} released from the SO_{X} absorbent 62 is exhausted into the atmosphere. This is also not preferable.

Therefore, in an embodiment of the present invention, the SO_{X} trap catalyst 13 is arranged upstream of the NO_{X} storage catalyst 14 to trap the SO_{X} contained in the exhaust gas by this SO_{X} trap catalyst 13 and thereby prevent SO_{X} from flowing into the NO_{X} storage catalyst 14. Next this SO_{X} trap catalyst 13 will be explained.

FIG. 3 illustrates the cross-section of the surface part of a substrate 65 of this SO_{X} trap catalyst 13. As shown in FIG. 3, the substrate 65 is formed with a coat layer 66 on its surface. This coat layer 66 carries a precious metal catalyst 67 diffused on its surface. In the embodiment according to the present invention, as the precious metal catalyst 67, platinum is used. As the ingredient forming the coat layer 66, for example, at least one element selected from potassium K, sodium Na, cesium Cs, and other such alkali metals, barium Ba, calcium Ca, and other such alkali earths, lanthanum La, yttrium Y, and other rare earths is used. That is, the coat layer 66 of the SO_{X} trap catalyst 13 exhibits a strong basicity.

Now, the SO_{X} contained in the exhaust gas, that is, SO₂, is oxidized on the platinum Pt 67 as shown in FIG. 3, then is trapped in the coat layer 66. That is, the SO₂ diffuses in the form of sulfate ions SO₄²⁻ in the coat layer 66 to form a sulfate. Note that as explained above, the coat layer 66 exhibits a strong basicity. Therefore, as shown in FIG. 3, part of the SO₂ contained in the exhaust gas is directly trapped in the coat layer 66.

In FIG. 3, the shading in the coat layer 66 shows the concentration of the trapped SO_{X}. As will be understood from FIG. 3, the SO_{X} concentration in the coat layer 66 is highest near the surface of the coat layer 66. The further in, the lower it becomes. If the SO_{X} concentration near the surface of the coat layer 66 increases, the surface of the coat layer 66 weakens in basicity and the SO_{X} trap ability weakens. Here, if the ratio of the amount of the SO_{X} trapped in the SO_{X} trap catalyst 13 to the amount of the SO_{X} in the exhaust gas is called the “SO_{X} trap rate”, if the basicity of the surface of the coat layer 66 is weakened, the SO_{X} trap rate falls along with that.

Note that the SO_{X} concentration near the surface of the coat layer 66 becomes higher after for example the engine is run over a long distance of about 50,000 km. Therefore, the SO_{X} trap ability of the SO_{X} trap catalyst 13 will not weaken over a long period. Note that when the SO_{X} trap ability weakens, in the embodiment according to the present invention, the temperature of the SO_{X} trap catalyst 13 is made to rise under a lean air-fuel ratio of the exhaust gas by temperature elevation control and thereby the SO_{X} trap ability is restored.

That is, if making the SO_{X} trap catalyst 13 rise in temperature under a lean air-fuel ratio of the exhaust gas, the SO_{X} present concentrated near the surface of the coat layer 66 diffuses toward the deep part of the coat layer 66 so that the SO_{X} concentration in the coat layer 66 becomes uniform. That is, the nitrate produced in the coat layer 66 changes from an unstable state where it concentrates near the surface of the coat layer 66 to the stable state where it diffuses uniformly in the coat layer 66 as a whole. If the SO_{X} present near the surface of the coat layer 66 diffuses toward the deep part of the coat layer 66, the SO_{X} concentration near the surface of the coat layer 66 falls, therefore when control for raising the temperature of the SO_{X} trap catalyst 13 ends, the SO_{X} trap ability is restored.

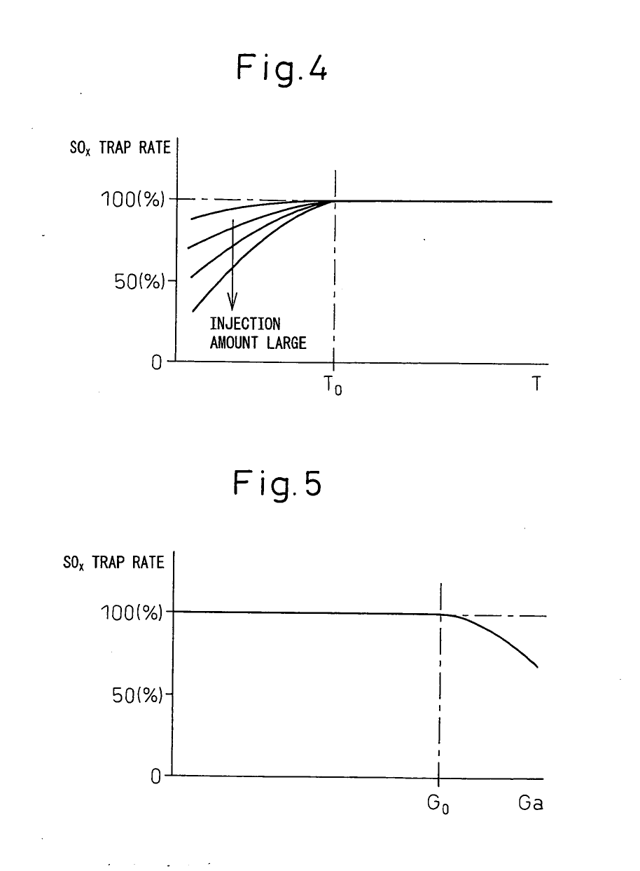

As explained above, the SO_{X} trap catalyst 13 will not weaken in SO_{X} trap ability over a long period of time. However, the SO_{X} trap rate changes in accordance with the engine operating state. This change of the SO_{X} trap rate is shown in FIG. 4 and FIG. 5.

FIG. 4 shows the relationship between the temperature T of the SO_{X} trap catalyst 13 and the SO_{X} trap rate. As shown in FIG. 4, when the temperature T of the SO_{X} trap catalyst 13 is higher than a predetermined limit temperature To determined by the SO_{X} trap catalyst 13, the SO_{X} trap rate is substantially 100%. If the temperature T of the SO_{X} trap catalyst 13 becomes lower than the limit temperature To, the platinum 67 weakens in activity, so the SO_{X} trap rate falls. Further, the larger the amount of fuel injection, that is, the greater the amount of SO_{X} included in the exhaust gas, the lower the SO_{X} trap rate.

FIG. 5 shows the relationship between the amount of intake air Ga, that is, the spatial velocity of the exhaust gas flowing through the SO_{X} trap catalyst 13, and the SO_{X} trap rate. As shown in FIG. 5, when the amount of intake air Go is smaller than a predetermined limit amount of air Go determined by the SO_{X} trap catalyst 13, the SO_{X} trap rate is substantially 100%. If the amount of intake air G exceeds the limit amount of air Go, the spatial velocity of the exhaust gas flowing through the SO_{X} trap catalyst 13 becomes higher, so the SO_{X} trap rate falls.

If the SO_{X} trap rate falls, the SO_{X} passing through the SO_{X} trap catalyst 13 flows into the NO_{X} storage catalyst 14. If the SO_{X} flows into the NO_{X} storage catalyst 14 in this way, that is, if the action of the SO_{X} trap catalyst 13 in blocking the inflow of SO_{X} into the NO_{X} storage catalyst 14 is stopped, there is no longer any meaning to arranging the SO_{X} trap catalyst 13 upstream of the NO_{X} storage catalyst 14. Therefore, when using the SO_{X} trap catalyst 13, it becomes necessary to maintain the SO_{X} trap rate at a high SO_{X} trap rate without the action of blocking inflow of SO_{X} to the NO_{X} storage catalyst 14 stopping.

Therefore, in the present invention, the vehicle drive power from the engine and the vehicle drive power from the electric power device are adjusted so as to utilize the electric power device to maintain the SO_{X} trap rate of the SO_{X} trap catalyst 13 at a predetermined high SO_{X} trap rate, for example substantially 100%.

That is, when the temperature T of the SO_{X} trap catalyst 13 is lower than the limit temperature To, if increasing the vehicle drive power from the engine, the exhaust temperature rises and therefore the temperature T of the SO_{X} trap catalyst 13 can be made higher than the limit temperature To. However, if at this time the amount of intake air Ga is lower than the limit amount of air Go, the SO_{X} trap rate rises to the predetermined high SO_{X} trap rate, but when the amount of intake air Ga is greater than the limit amount of air Go, the SO_{X} trap rate cannot rise to the predetermined high SO_{X} trap rate.

Therefore, in the embodiment according to the present invention, when the temperature T of the SO_{X} trap catalyst 13 is less than the limit temperature To, the vehicle drive power from the engine and the vehicle drive power from the electric power device are adjusted in accordance with whether the SO_{X} trap rate becomes a predetermined high SO_{X} trap rate when increasing the output torque of the engine.

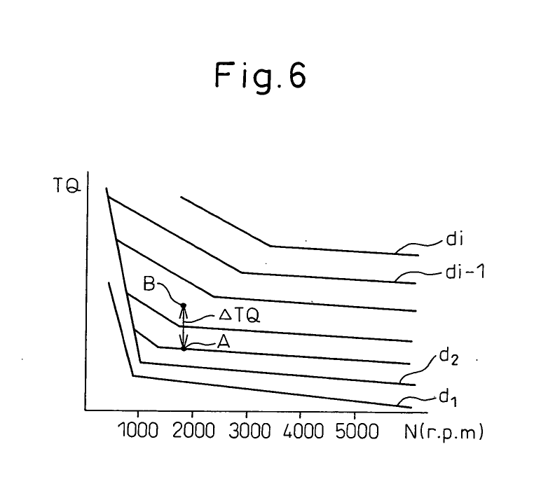

That is, specifically speaking, when increasing the output torque of the engine, when the SO_{X} trap rate becomes a predetermined high SO_{X} trap rate, the output torque of the engine is increased from the required torque. To explain this, FIG. 6 shows the relationship between the equivalent depression amounts d₁ to di of the accelerator pedal 32, the engine speed N, and the output torque of the engine TQ. Note that in FIG. 6, the amount of depression of the accelerator pedal 32 becomes greater from d₁ toward di. In FIG. 6, when the amount of depression of the accelerator pedal 32 and the engine speed N are determined, the output torque TQ at that time becomes the required torque.

That is, for example assume now the operating state shown by the point A in FIG. 6. At the time of such an operating state, the temperature T of the SO_{X} trap catalyst 13 becomes less than the limit temperature To and at this time, if increasing the output torque of the engine, when the SO_{X} trap rate becomes a predetermined high SO_{X} trap rate, the output torque of the engine is gradually increased from the required torque shown by the point A of FIG. 6 to the output torque shown by for example the point B by ΔTQ. Due to this, the SO_{X} trap rate is increased to substantially 100%.

Further, in this embodiment, when the output torque of the engine is made to increase by ΔTQ, the increase ΔTQ of the output torque is made to be consumed for the generation of electric power by the electric power device so that the vehicle drive power is not increased. That is, at this time, the electric power device is operated as a generator and the increase ΔTQ of the output torque is used for the action of the generator of generating power.

As opposed to this, the temperature T of the SO_{X} trap catalyst 13 becomes less than the limit temperature To, and when the SO_{X} trap rate will not become a predetermined high SO_{X} trap rate even if increasing the output torque of the engine, that is, when the amount of intake air Ga is greater than the limit amount of air Go, SO_{X} continues to flow into the NO_{X} storage catalyst 14 even if increasing the output torque of the engine. Therefore, there is no longer any meaning in arranging the SO_{X} trap catalyst 13 upstream of the NO_{X} storage catalyst 14. Therefore, at this time, the engine is stopped and the vehicle is driven by the electric power device. That is, at this time, if the output torque of the engine is for example the output torque shown by the point A in FIG. 6, the electric power device is driven so as to generate the output torque shown by the point A.

In this way, in the embodiment according to the present invention, when the temperature T of the SO_{X} trap catalyst 13 becomes less than the limit temperature To and the amount of intake air Ga is greater than the limit amount of air Go, the engine is stopped. Such an operating state mainly occurs at the time of engine warmup operation. Therefore, at the time of engine warmup operation, sometimes the engine is stopped.

On the other hand, in the embodiment according to the present invention, when the temperature T of the SO_{X} trap catalyst 13 is higher than the limit temperature To, the vehicle is driven by the engine so long as the SO_{X} trap rate does not drop due to a reason other then the drop of the temperature of the SO_{X} trap catalyst 13. As opposed to this, when the temperature T of the SO_{X} trap catalyst 13 is higher than the limit temperature To, when the amount of intake air Ga becomes greater than even the limit amount of air Go and the SO_{X} trap rate falls, to lower the temperature T of the SO_{X} trap catalyst 13, the output torque of the engine is decreased from the required torque. At this time, to prevent the drive power of the vehicle from changing, the decrease in the output torque is made up for by the vehicle drive power from the electric power device.

That is, for example, now assume the operating state shown by the point B in FIG. 6. At this time, if the temperature T of the SO_{X} trap catalyst 13 is higher than the limit temperature To and the amount of intake air Ga becomes greater than the limit amount of air Go, the output torque of the engine is decreased from the required torque shown by the point B of FIG. 6 to for example the output torque shown by the point A gradually by ΔTQ and the decrease of this output torque is made up for by the drive power of the electric motor 27.

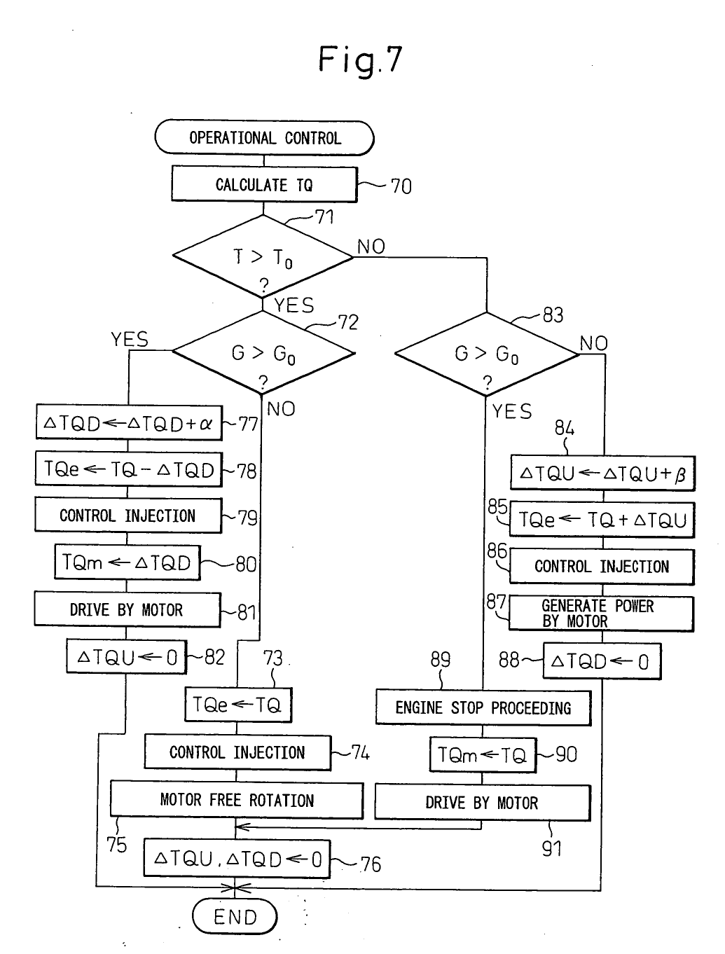

FIG. 7 shows the operational control routine. This routine is executed by interruption every constant time period.

Referring to FIG. 7, first, at step 70, the required torque TQ is calculated from the relationship shown in FIG. 6 based on the amounts of depression d₁ to di of the accelerator pedal 32 and the engine speed N. Next, at step 71, it is judged if the temperature T of the SO_{X} trap catalyst 13 estimated by the temperature sensor 15 is higher than the limit temperature To. When T>To, the routine proceeds to step 72, where it is judged if the amount of intake air G detected by the intake air detector 8 is greater than the limit amount of air Go. When G≦Go, the routine proceeds to step 73.

As will be understood from FIG. 4 and FIG. 5, when T>To and G≦Go, the SO_{X} trap rate becomes substantially 100%. Therefore, when the SO_{X} trap rate is substantially 100%, it is learned that the routine proceeds to step 73. At step 73, the required torque TQ calculated at step 70 is made the final required torque of the engine. Next, at step 74, the fuel injection is controlled so as to give this final required torque. Next, at step 75, the electric motor 27 is set to a state where it can freely rotate. Next, at step 76, the torque correction values ΔTQU, ΔTQD are cleared.

As opposed to this, when it is judged at step 72 that G>Go, to make the SO_{X} trap rate rise to substantially 100%, the routine proceeds to step 77, where the output torque of the engine is gradually decreased. That is, first, at step 77, the torque decrease correction amount ΔTQD is increased by a constant value α. Next, at step 78, the required torque TQ calculated at step 70 is decreased by the torque decrease correction amount ΔTQD and the result is made the final required torque of the engine TQe (=TQ−ΔTQD). Next, at step 79, the fuel injection is controlled so as to obtain the final required torque TQe.

Next, at step 80, the torque decrease correction amount ΔTQD is made the output torque TQm of the electric motor 27 for driving the vehicle. Next, at step 81, the electric motor 27 is driven so as to generate the output torque TQm. Next, at step 82, the torque increase correction amount ΔTQU is cleared.

On the other hand, when it is judged at step 71 that T≦To, the routine proceeds to step 83 where it is judged if the amount of intake air G is larger than the limit amount of air Go. When G≦Go, the SO_{X} trap catalyst 13 is raised in temperature, whereby the SO_{X} trap rate can be made substantially 100%. Therefore, when G≦Go, the routine proceeds to step 84 where the output torque of the engine is gradually increased.

That is, first, at step 84, the torque increase correction amount ΔTQU is increased by a constant value β. Next, at step 85, the required torque TQ calculated at step 70 is increased by the torque increase correction amount ΔTQU and the result is made the final required torque of the engine TQe (=TQ+ΔTQU). Next, at step 86, fuel injection is controlled so that this final required torque TQe is obtained.

Next, at step 87, the electric motor 27 is made to operate as a generator, and the torque increase correction amount ΔTQU is consumed for generating power. Next, at step 88, the torque decrease correction amount ΔTQD is cleared.

As opposed to this, when it is judged at step 83 that G>Go, even if adjusting the output torque of the engine, the SO_{X} trap rate cannot be raised to substantially 100%. Therefore, at this time, the routine proceeds to step 89 where the engine is stopped. Next, at step 90, the required torque TQ calculated at step 70 is made the output torque TQm of the electric motor 27 for driving the vehicle. Next, at step 91, the electric motor 27 is driven so as to generate the output torque TQm. At this time, the transmission 25 is set to the neutral position. Next, the routine proceeds to step 76.

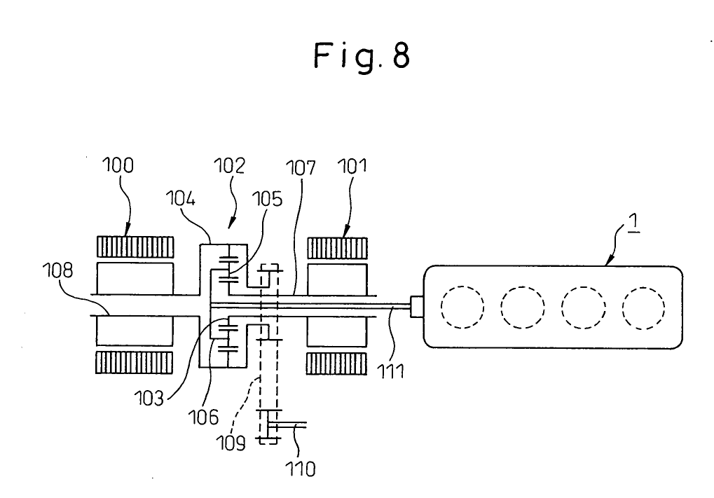

Next, another embodiment of the electric power device will be explained with reference to FIG. 8.

If referring to FIG. 8, in this embodiment, electric power device comprises a pair of motor generators 100, 101 operating as an electric motor and generator and a planetary gear mechanism 102. This planetary gear mechanism 102 is provided with a sun gear 103, ring gear 104, planetary gear 105 arranged between the sun gear 103 and ring gear 104, and planetary carrier 106 carrying the planetary gear 105. The sun gear 103 is coupled with a shaft 107 of the motor/generator 101, while the planetary carrier 106 is coupled with an output shaft 111 of the internal combustion engine 1. Further, the ring gear 104 is on the one hand coupled with a shaft 108 of the motor/generator 100 and on the other hand is coupled with an output shaft 110 coupled to the drive wheels via a belt 109. Therefore, it is learned that when the ring gear 104 turns, the output shaft 110 is made to turn along with it.

Explanation of the detailed operation of this electric power device will be omitted, but generally speaking, the motor/generator 100 mainly operates as an electric motor, while the motor/generator 101 mainly operates as a generator.

That is, when driving the vehicle by only the output of the internal combustion engine 1, the rotation of the motor/generator 101 is stopped. At this time, when the output shaft 111 of the internal combustion engine 1 rotates, the ring gear 104 is made to rotate. If the ring gear 104 is made to rotate, the rotational force of the ring gear 104 is transmitted through the belt 109 to the output shaft 110 whereby the vehicle is driven. At this time, the motor/generator 100 is idling.

On the other hand, if driving the vehicle by only electric power, the operation of the internal combustion engine 1 is stopped and the vehicle is driven by the motor/generator 100. That is, if the motor/generator 100 is made to rotate, the ring gear 104 is made to rotate, the rotational power of the ring gear 104 is transmitted through the belt 109 to the output shaft 110, and thereby the vehicle is driven. On the other hand, at this time, the planetary carrier 106 is not rotating, so if the ring gear 104 rotates, the sun gear 103 is made to rotate. At this time, the motor/generator 101 is idling.

On the other hand, when superposing electric power on the drive power of the internal combustion engine, the motor/generator 100 is driven in addition to the internal combustion engine 1. At this time, the rotational force of the planetary carrier 106 is superposed on the rotational force of the ring gear 104. On the other hand, at this time, the motor/generator 101 acts to generate power.

1. An exhaust purification device of compression ignition type internal combustion engine arranging, in an engine exhaust passage, an SO_{X} trap catalyst able to trap SO_{X} contained in exhaust gas and arranging, in the exhaust passage downstream of the SO_{X} trap catalyst, an NO_{X} storage catalyst storing NO_{X} contained in the exhaust gas when the air-fuel ratio of an inflowing exhaust gas is lean and releasing stored NO_{X} when the air-fuel ratio of the inflowing exhaust gas becomes a stoichiometric air-fuel ratio or rich, wherein said device is provided with an electric power device able to generate vehicle drive power separate from the vehicle drive power from the engine and able to generate electric power from the engine, and the vehicle drive power from the engine and the vehicle drive power from the electric power device are adjusted so that a SO_{X} trap rate of the SO_{X} trap catalyst is maintained at a predetermined high SO_{X} trap rate.

2. An exhaust purification device of compression ignition type internal combustion engine as set forth in claim 1, wherein said SO_{X} trap catalyst has a property of the SO_{X} trap rate falling when a temperature of the SO_{X} trap catalyst becomes less than a predetermined limit temperature, and when the temperature of the SO_{X} trap catalyst is less than said limit temperature, the vehicle drive power from the engine and the vehicle drive power from the electric power device are adjusted in accordance with whether the SO_{X} trap rate becomes said predetermined high SO_{X} trap rate when increasing the output torque of the engine.

3. An exhaust purification device of compression ignition type internal combustion engine as set forth in claim 2, wherein when the SO_{X} trap rate becomes said predetermined high SO_{X} trap rate when increasing the output torque of the engine, the output torque of the engine is increased with respect to a required torque and an increase in the output torque is consumed for the power generation action of the electric power device.

4. An exhaust purification device of compression ignition type internal combustion engine as set forth in claim 2, wherein when the SO_{X} trap rate will not become said predetermined high SO_{X} trap rate when increasing the output torque of the engine, the engine is stopped and the vehicle is driven by the electric power device.

5. An exhaust purification device of compression ignition type internal combustion engine as set forth in claim 2, wherein, when the amount of intake air is smaller than a predetermined limit amount of intake air, it is judged that the SO_{X} trap rate becomes said predetermined high SO_{X} trap rate when increasing the output torque of the engine and, when the amount of the intake air is greater than the predetermined limit amount of intake air, it is judged that the SO_{X} trap rate will not become said predetermined SO_{X} trap rate when increasing the output torque of the engine.

6. An exhaust purification device of compression ignition type internal combustion engine as set forth in claim 1, wherein said SO_{X} trap catalyst has a property of the SO_{X} trap rate falling when a temperature of said SO_{X} trap catalyst becomes less than a predetermined limit temperature, and when the temperature of the SO_{X} trap catalyst is higher than said limit temperature, the vehicle is driven by the engine so long as the SO_{X} trap rate does not fall due to a reason other than a drop of temperature of the SO_{X} trap catalyst.

7. An exhaust purification device of compression ignition type internal combustion engine as set forth in claim 6, wherein when the temperature of the SO_{X} trap catalyst is higher than said limit temperature, if the amount of intake air becomes greater than a predetermined limit amount of air and the SO_{X} trap rate falls, the output torque of the engine is decreased from a required torque and the decrease of the output torque is made up for by vehicle drive power from the electric power device.
